(19) United States
(12) Patent Application Publication
(10) Pub. No.: US 2026/0161794 A1
(43) Pub. Date: Jun. 11, 2026

(54) TECHNIQUES FOR CONTEXT AWARE SECURING OF VERSION CONTROL SYSTEMS

(71) Applicant: Wiz, Inc., New York, NY (US)

(72) Inventors: Amir LANDE BLAU, Tel Aviv (IL); Or HELLER, Tel Aviv (IL); Alon WEISS, Tel Aviv (IL); Benny HOLTZER, Ramat Gan (IL); Daniel Hershko SHEMESH, Givat-Shmuel (IL)

(73) Assignee: Wiz, Inc., New York, NY (US)

(21) Appl. No.: 18/974,109

(22) Filed: Dec. 9, 2024

(51) Int. Cl. G06F 21/57

(52) U.S. Cl. CPC G06F 21/577

(57) ABSTRACT

A system and method for cybersecurity remediation prioritization in a cloud computing environment is presented. The method includes inspecting a development pipeline of a production cloud computing environment for a cybersecurity issue; detecting the cybersecurity issue in the development pipeline; generating an alert based on the detected cybersecurity issue, the alert including a first priority indicator; determining an impact of the cybersecurity issue on the production cloud computing environment; updating the first priority indicator to a second priority indicator based on the determined impact; and initiating a remediation action in the cloud computing environment based on the second priority indicator.

### TECHNICAL FIELD

The present disclosure relates generally to cybersecurity, more specifically cybersecurity remediation prioritization in a cloud computing environment.

### BACKGROUND

Version control systems manage changes to files, particularly source code, over time. They enable multiple people to collaborate by tracking modifications, merging updates, and maintaining a history of versions. This ensures that previous versions can be restored if necessary, and conflicts from concurrent changes are resolved systematically. These systems also provide a centralized repository or distributed model, where each collaborator has a complete copy of the project's history. By maintaining a comprehensive log of edits, additions, and deletions, version control systems enhance project management, collaboration, and code integrity throughout the development lifecycle.

However, this also presents a risk for cybersecurity, as multiple people collaborating are not always aware of what each person is doing, what code is being committed, etc., and therefore it is possible to introduce risk into a computing environment.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include inspecting a development pipeline of a production cloud computing environment for a cybersecurity issue. The method may also include detecting the cybersecurity issue in the development pipeline. The method may furthermore include generating an alert based on the detected cybersecurity issue, the alert including a first priority indicator. The method may in addition include determining an impact of the cybersecurity issue on the production cloud computing environment. The method may moreover include updating the first priority indicator to a second priority indicator based on the determined impact. The method may also include initiating a remediation action in the cloud computing environment based on the second priority indicator. Other embodiments of this aspect include corresponding computer systems, apparatus, and computer programs recorded on one or more computer storage devices, each configured to perform the actions of the methods.

Implementations may include one or more of the following features. The method may include: inspecting an infrastructure as code (IaC) platform of the development pipeline for the cybersecurity issue. The method may include: detecting a code object in the IaC platform, the code object utilized to deploy a workload in the production cloud computing environment. The method may include: inspecting the code object for the cybersecurity issue. The method may include: inspecting a CI/CD environment of the development pipeline for the cybersecurity issue. The method may include: inspecting the production cloud computing environment for a cybersecurity object; and detecting a cybersecurity risk based on the cybersecurity object and the cybersecurity issue. The method may include: determining the impact of the cybersecurity issue further on an entity of the production cloud computing environment. The method may include: inspecting a cloud log of the production cloud computing environment for a data record respective of the entity; and detecting a compromised entity in response to detecting a type of the data record. The method may include: initiating another remediation action based on the detected compromised entity. The method may include: detecting a code object in a code repository; and detecting the cybersecurity issue based on the code object. Implementations of the described techniques may include hardware, a method or process, or a computer tangible medium.

In one general aspect, non-transitory computer-readable medium may include one or more instructions that, when executed by one or more processors of a device, cause the device to: inspect a development pipeline of a production cloud computing environment for a cybersecurity issue; detect the cybersecurity issue in the development pipeline; generate an alert based on the detected cybersecurity issue, the alert including a first priority indicator; determine an impact of the cybersecurity issue on the production cloud computing environment; update the first priority indicator to a second priority indicator based on the determined impact; and initiate a remediation action in the cloud computing environment based on the second priority indicator. Other embodiments of this aspect include corresponding computer systems, apparatus, and computer programs recorded on one or more computer storage devices, each configured to perform the actions of the methods.

In one general aspect, a system may include one or more processors configured to: include inspect a development pipeline of a production cloud computing environment for a cybersecurity issue. The system may furthermore detect the cybersecurity issue in the development pipeline. The system may in addition generate an alert based on the detected cybersecurity issue, the alert including a first priority indicator. The system may moreover determine an impact of the cybersecurity issue on the production cloud computing environment. The system may also update the first priority indicator to a second priority indicator based on the determined impact. The system may furthermore initiate a remediation action in the cloud computing environment based on the second priority indicator. Other embodiments of this aspect include corresponding computer systems, apparatus, and computer programs recorded on one or more computer storage devices, each configured to perform the actions of the methods.

Implementations may include one or more of the following features. The system where the one or more processors are further configured to: inspect an infrastructure as code (IaC) platform of the development pipeline for the cybersecurity issue. The system where the one or more processors are further configured to: detect a code object in the IaC platform, the code object utilized to deploy a workload in the production cloud computing environment. The system where the one or more processors are further configured to: inspect the code object for the cybersecurity issue. The system where the one or more processors are further configured to: inspect a CI/CD environment of the development pipeline for the cybersecurity issue. The system where the one or more processors are further configured to: inspect the production cloud computing environment for a cybersecurity object; and detect a cybersecurity risk based on the cybersecurity object and the cybersecurity issue. The system where the one or more processors are further configured to: determine the impact of the cybersecurity issue further on an entity of the production cloud computing environment. The system where the one or more processors are further configured to: inspect a cloud log of the production cloud computing environment for a data record respective of the entity; and detect a compromised entity in response to detecting a type of the data record. The system where the one or more processors are further configured to: initiate another remediation action based on the detected compromised entity. The system where the one or more processors are further configured to: detect a code object in a code repository; and detect the cybersecurity issue based on the code object. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a monitored cloud computing environment utilizing infrastructure as code (IaC) utilized to describe the various embodiments.

FIG. 2 is a flowchart of a method for inspecting configuration code utilizing a security graph, implemented in accordance with an embodiment.

FIG. 3 is a schematic illustration of a portion of a security graph for cybersecurity risk assessment of virtual instances in a cloud computing environment, implemented in accordance with an embodiment.

FIG. 4 is a code object, shown in accordance with an embodiment.

FIG. 5 is a schematic illustration of a unified policy engine across multiple cloud environments, implemented according to an embodiment.

FIG. 6 is a flowchart for generating an inspection instruction based on a detected code object, implemented in accordance with an embodiment.

FIG. 7 is a flowchart for detecting a misconfiguration and a threat, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for a system and method including techniques for context aware securing of version control.

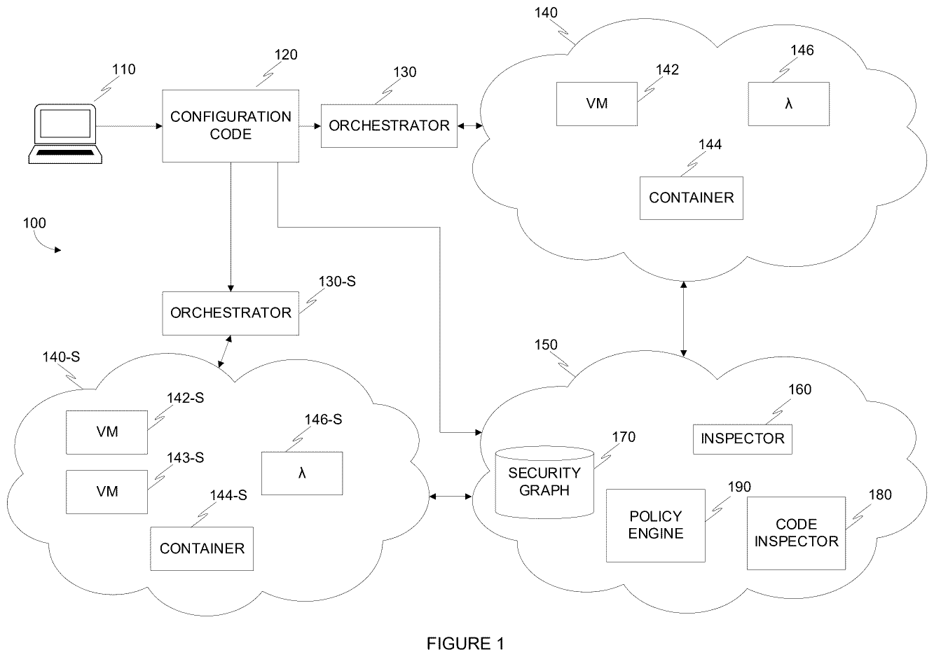

FIG. 1 is a network diagram 100 of a monitored cloud computing environment utilizing infrastructure as code (IaC) utilized to describe the various embodiments.

A client device 110 generates a configuration code file 120 based on input from one or more users (e.g., software programmers). In an embodiment, a client device is a personal computer, a tablet, a laptop, and the like. In some embodiment, a client device 110 is used to access a server (not shown) which provides a computing environment into which input can be provided. It should be apparent that the client device 110 is shown here for simplicity and pedagogical purposes, and that the configuration code file 120 is generated, in other embodiments, by the client device, a virtual workload in a cloud computing environment, a combination thereof, and the like. In certain embodiments, the configuration code file 120 is generated by multiple different client devices. For example, a plurality of users may each utilize a different client device and update a single configuration code file 120, for example, with code objects. In some embodiments, a single client device 110 generates multiple configuration code files.

In an embodiment the configuration code file 120 is implemented in a declaratory computer language. In a declaratory computer language, a user declares resources they would like to have as code objects, and an orchestrator, such as orchestrator 130, is configured to deploy workloads in a cloud computing environment based on the declarations. For example, an orchestrator 130 is configured, in an embodiment, to translate a declaratory code to a configuration code, which includes instructions which when executed configure a cloud computing environment to deploy a workload, virtual instance, and the like.

In certain embodiments, multiple configuration code files 120 may be utilized. For example, a user may operate multiple cloud environments, each with its own configuration code. For example, a first configuration code file is directed to deploying a cloud computing environment over Microsoft® Azure, while a second configuration code file is directed to deploying a cloud computing environment over Amazon@ Web Services (AWS).

As another example, a user can declare a first resource type (e.g., virtual machine) for a first cloud environment (e.g., AWS) and for a second cloud environment (e.g., Google® Cloud Platform—GCP) in a first configuration code file, and a second resource type (e.g., software container) for the first cloud environment (AWS) and the second cloud environment (GCP) in a second configuration code file.

In some embodiments, a code file, code object, and the like, are stored in a version control system, code repository, and the like. For example, in an embodiment, a version control system (VCS) is implemented utilizing Github®.

In an embodiment, an orchestrator 130 is configured to receive the configuration code file 120. In certain embodiments, the orchestrator 130 is configured to initiate actions in a cloud computing environment 140, for example, to deploy workloads, instances, user accounts, service accounts, combinations thereof, and the like, based on declarations of the configuration code file 120. In an embodiment, an instance is a virtual instance, and may be, for example a virtual machine 142, software container 144, a serverless function 146, and the like.

In some embodiments, the orchestrator 130 is configured to deploy workloads by assigning (also known as provisioning) cloud computing environment resources, such as processors, memory, storage, etc. to the workload. In an embodiment, workloads are deployed in a production environment, which is a cloud computing environment having operable code, used for providing access to data and providing software services. In some embodiments, configuration code is implemented in a development (dev) environment, which also utilizes a cloud computing environment.

In some embodiments, a plurality of workloads are associated with a first code object (not shown) of the configuration code file 120. Workloads which are all deployed based on a same code object (i.e., the first code object) are known as a virtual instance (or “instance”) of the first code object. In an embodiment, associating a workload with a code object includes assigning a name to the instance based on an identifier of the code object.

This provides an advantage where it is required to deploy multiple instances which share similar configurations, such as web servers providing access to a website. Rather than configure each instance manually and individually, an orchestrator 130 is configured to deploy a number of the same workload based on the configuration code file 120.

In some embodiments the orchestrator 130 may configure a cloud-native orchestrator (not shown) in the cloud computing environment 140 to deploy the instances. This may be advantageous, for example, where instances need to be deployed in different cloud environments.

For example, the same instances may be deployed simultaneously on Google® Cloud Platform (GCP), Amazon® Web Services (AWS), or Microsoft® Azure. This can be achieved by configuring the orchestrator 130 to generate native instructions for a cloud native orchestrator in each environment to deploy such instances. The native instructions are generated by the orchestrator 130 in an embodiment. The instructions are generated based on objects detected in the configuration code file 120.

This method of deploying instances decreases errors by eliminating the need for a user to manually deploy each instance and configure each instance separately, and is also thus a faster method of deployment. A human is not able to consistently and reliably initiate deployment of virtual instances, and then configure hundreds or thousands of such instances to match the same specification. In the example above a first load balancer may be deployed in a first cloud computing environment, and a second load balancer may be deployed in a second cloud computing environment, each cloud computing environment having different infrastructure from each other, wherein the first load balancer and the second load balancer are deployed based on the same code object from a configuration code file.

In an embodiment, the first cloud computing environment 140 is coupled with a second cloud computing environment 150, which is configured to inspect the first cloud computing environment 140 for cybersecurity threats. In an embodiment, the second cloud computing environment 150 (also referred to as inspection environment 150) is further configured to receive the configuration code file 120.

In some embodiments, the second cloud environment 150 is utilized for inspecting the first cloud computing environment 140 and generating cybersecurity risk assessments for instances deployed in the first cloud computing environment 140.

In certain embodiments, the second cloud environment 150 includes a plurality of inspectors, such as inspector 160. An inspector is a workload which is configured to inspect another workload for cybersecurity objects, such as a secret, a file, a folder, a registry value, a weak password, a certificate, a malware object, a hash, a misconfiguration, a vulnerability, an exposure, a combination thereof, and the like. In an embodiment, an inspector 180 is configured to inspect for a plurality of cybersecurity object types.

For example, in an embodiment, an inspector is configured to inspect the virtual machine 142 for a predetermined cybersecurity object, in response to receiving an instruction to inspect the virtual machine 142. In an embodiment the instruction is received through an API (not shown) of the first cloud computing environment 140. In some embodiments, an inspectable disk is generated based on a volume (not shown) attached to the virtual machine 142, and the inspectable disk is provided to the second cloud computing environment 150 for inspection. In an embodiment, generating an inspectable disk includes generating a clone of the volume, generating a copy of the volume, generating a snapshot of the volume, and the like.

In an embodiment, a software container is deployed in the second cloud computing environment 150 and attached to a volume generated in the second cloud computing environment 150 based on the received snapshot. The inspector 160 is configured, in an embodiment, to inspect the attached volume for a predefined cybersecurity object type. In an embodiment, the inspector 160 is configured to generate data which is stored on a security graph 170. In some embodiments, a node is stored on the security graph 170 to represent an inspected resource. In an embodiment, data generated by the inspector 160 is stored on the node representing the workload which the inspector 160 inspected for a cybersecurity object.

In an embodiment, the security graph 170 is stored on a graph database. The security graph 170 includes a representation of a cloud computing environment. In an embodiment, the representation includes a plurality of nodes, at least a portion of which each represent a resource or a principal. A resource is a cloud entity which provides access to a service, computer hardware (e.g., processor, memory, storage, and the like), and the like. In an embodiment, a resource is a workload, such as a virtual machine, serverless function, software container, and the like. A principal is a cloud entity which is authorized to initiate actions in a cloud computing environment, and is authorized to act on a resource. In an embodiment, a principal is a user account, a user group, a service account, and the like.

In certain embodiments, the second cloud environment 150 further includes a policy engine 190. In an embodiment the policy engine 190 is implemented as a workload, such as a virtual machine, software container, and the like. The policy engine 190 includes, in an embodiment, a rule engine having a plurality of rules. In an embodiment each rule includes a condition and an action. A rule may be implemented, for example, as an ‘if-then’ statement. In an embodiment, the policy engine 190 is configured to periodically check if one or more of the rules are violated by a workload, account, and the like, in the first cloud computing environment 140. The policy engine 190 further includes, in an embodiment, a policy which indicates a permission associated with workloads, accounts, and the like. For example, a policy states that a user account belonging to a first user group is authorized to access the VM 142. In an embodiment, the policy engine 190 is implemented in the first cloud environment 140, and accessible by the second cloud environment 150.

In some embodiments, the configuration code 120 is further utilized by a staging environment orchestrator 130-S. While this embodiment utilizes an orchestrator 130 for a production cloud environment 140, and a staging environment orchestrator 130-S for a staging cloud environment 140-S, it should be apparent that other embodiments are possible without departing from the scope of this disclosure. For example, a single orchestrator is used for both the production and staging environments, in an embodiment.

A staging environment is a cloud computing environment which is as identical as possible to the production environment. A staging environment may include test workloads, relatively small configurations drifts, and the like for testing their viability of such deviations for the production environment. Typically, workloads are deployed in a staging environment prior to deployment in a production environment, so as to detect any issues which the workload may cause in the production environment.

In an embodiment, the staging cloud environment 140-S is a cloud computing environment which is practically identical to the production cloud environment 140. In some embodiments, the staging cloud environment 140-S further includes a test workload. In an embodiment, the test workload is utilized to determine if a workload deployed in the staging cloud environment 140-S can handle a volume of expected traffic.

For example, a second VM 143-S is a workload which is deployed in the staging cloud environment 140-S, but not yet deployed in the production cloud environment 140. A first VM 142-S is a workload identical to VM 142, a software container 144-S is a workload identical to the software container 144 deployed in the production cloud environment 140, and a serverless function 146-S is identical to the serverless function 146. In an embodiment, a pair of workloads are considered identical if they are identical in everything other than an identifier, and a deployment environment.

It is common that workloads in the production environment 140 are the cause of alert generation, based for example on policies of the production cloud environment 140. In an embodiment a policy engine 190 is configured to receive an instruction to generate an exception to an error.

For example, if a VM 142 triggers an error (i.e., violates a policy), an exception is added to the policy engine 190, which results in ignoring the error when the policy is applied to the VM 142, according to an embodiment. In an embodiment, an exception is implemented as a rule, additional condition to an existing rule, and the like, in the policy engine 190.

However, as the exception is specific to the VM 142, the corresponding virtual machine of the staging environment (VM 142-S), which is identical to the VM 142, would trigger an error, based on violating the same policy. This results in generating multiple alerts for an issue which was previously resolved (i.e., by generating the exception). It is desirable to reduce the number of generated alerts as this improves user experience, for example by reducing alert fatigue. It is further desirable to reduce redundant data which requires additional storage resources.

In an embodiment, a code object of a configuration code is represented in the security graph 170 by a code object node, which is connected to a first instance node representing a first instance deployed in a production environment (e.g., production environment 140) and connected to a second instance node representing a second instance, corresponding to the first instance, deployed in a staging environment (e.g., staging environment 140-S), wherein the second instance and the first instance are both initially deployed based on the code object represented by the code object node.

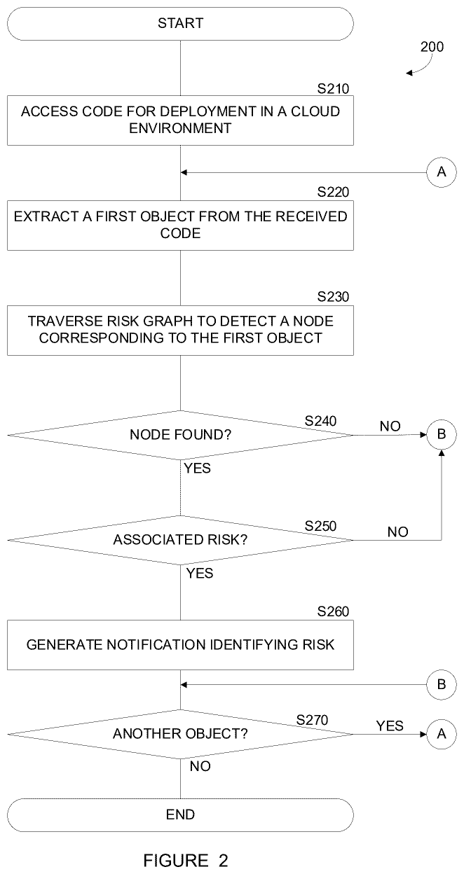

FIG. 2 is an example flowchart 200 of a method for inspecting configuration code utilizing a security graph, implemented in accordance with an embodiment. In an embodiment, configuration code in a development (dev) environment is inspected based on a security graph which is generated at least in part based on a production environment.

A production environment is rarely, if at all, identical to the environment which is deployed initially by code. This is due to, for example, upgrades and patches implemented in the production environment to address issues caused by the code deployment. Drifting configuration, or configuration drift, describes how a production environment, over time, ‘drifts’ further away from the initial configuration code design. Therefore, inspecting only one environment for cybersecurity threats is not enough, and it is advantageous to inspect both.

In an embodiment, the security graph includes representations of the configuration code (e.g., representing code objects) and the production environment (e.g., representing resources and principals). By inspecting a configuration code file based on a security graph generated from data of a production environment, insight can be gained, and deployment issues may be caught early on, for example to identify instances which if deployed based on a current version of configuration code would include a version of software which the production environment has already upgraded to a newer version. In an embodiment, the method is performed by a configuration code inspector, such as the code inspector 180.

At S210, configuration code is received. In an embodiment, the configuration code includes a plurality of code objects. In certain embodiments, a portion of the code objects correspond to instances which are deployed in a cloud computing environment. In an embodiment, the configuration code is scanned or otherwise inspected as a textual object. For example, a configuration code is searched for regular expressions (regex), strings, and the like.

According to an embodiment, receiving configuration code includes accessing a code repository, a version control system, and the like, to extract therefrom a code file, a code object, a combination thereof, and the like.

At S220, a first code object is extracted from the received code. Extracting a code object includes, in an embodiment, searching the text of a configuration code file for a predetermined string. For example, a code object may be a text field identifying a type of workload, a name of a workload, a network address, a name in a namespace, a role, a permission, and the like. In some embodiments, a plurality of code objects are extracted from the received code.

At S230, a security graph is traversed to detect a node in the graph corresponding to the extracted first code object. In an embodiment, traversing the security graph includes sending a request through an API of a graph database hosting the security graph to search the graph for a string, a value, and the like, which corresponds to the first code object. For example, if the first code object includes a secret, such as a private key (i.e., an alphanumerical representation), the security graph is traversed to detect a node which represents a matching public key (e.g., public key node). In an embodiment, the public key node is connected to a resource node representing a resource which utilizes the public key.

In certain embodiments, the code object is traced to a cloud object by querying a CLI, generating a CI job, etc., in order to determine what cloud objects are deployed, operational, and the like, in a cloud computing environment, which are based on the code object.

In some embodiments, a query directed at the security graph includes a plurality of clauses. In an embodiment, multiple-clause query is generated to search for container nodes (i.e., nodes representing containers) which are connected to a node representing the public key. It is noted that detecting a node which corresponds to the extracted first object includes, in an embodiment, detecting a node which is not a node representing a workload corresponding to the first object.

For example, executing code of the first code object results, in an embodiment, in deploying a first load balancer in a virtual private cloud (VPC). In an embodiment, a node is generated in a security graph to represent the first load balancer deployed in a cloud computing environment. The node representing the load balancer is connected to a node representing the VPC.

An advantage of the disclosed method is that attributes of the first code object detected in the graph allows detecting nodes representing cybersecurity issues, nodes representing workloads, enrichment nodes, and the like, prior to the generation of an instance based on the code object. This allows detecting a security risk in an instance prior to it being deployed in a computing environment. In the above example, as the code of the first code object includes instructions to deploy in the VPC, the VPC node is detected (based, for example, on detecting an identifier of the VPC in the code) in the security graph. Cybersecurity risks represented by nodes connected to the VPC node are detected, for example by querying the security graph.

At S240, a check is performed to determine if a node is detected. If ‘no’ execution may continue at S270. In an embodiment, if a node is not detected (e.g., the node does not exist), a new node is generated in the security graph to represent the first code object. If a node is detected execution continues to S250.

At S250, a check is performed to determine if the detected node corresponds to a previously determined cybersecurity issue, such as a cybersecurity risk factor, vulnerability, misconfiguration, and the like. A risk factor, vulnerability, misconfiguration, and the like, may be, for example, access to a network resource (such as the internet), access from a network resource, outdated software, privilege escalation, and the like. In an embodiment, a risk factor score is further determined. In some embodiments, the score indicates the severity of the risk, such as ‘low’, ‘medium’, ‘high’, and ‘critical’. In an embodiment, the previously determined cybersecurity issue is detected by inspecting a disk for a cybersecurity object. In some embodiments, a detected cybersecurity issue is represented as a node in a security graph, connected to a node representing a resource on which the cybersecurity issue was detected.

In an embodiment, a mitigation instruction corresponding to the risk factor score is executed. In some embodiments, the risk factor is indicated by metadata associated with the detected node of S240. If the detected node corresponds to a previously determined cybersecurity issue execution continues at S260; otherwise, execution continues at S270.

In an embodiment, a vulnerability is represented on the security graph by a node. As an example, a node representing a workload is connected to a node representing a vulnerability. Where a workload node is the detected node, a cybersecurity vulnerability is associated with the code object.

At optional S260 a notification is generated to indicate that a security risk has been detected in the configuration code. In an embodiment the notification is sent to a client device, a user account, a combination thereof, and the like, which authored the code. Code authors are determined, in an embodiment, by a user account identifier present in the configuration code.

In some embodiments, the notification includes an indicator to specify why the notification is generated. In certain embodiments an instruction to perform a mitigation action is generated. In the example above, an alert (i.e., notification) is generated in response to detecting that a workload includes an outdated software version, and the alert includes the current software version which would need to be configured in the configuration code in order to mitigate the risk of deploying a workload with an outdated software version.

At S270 a check is performed to determine if another code object should be inspected. If ‘yes’ execution continues at S220, otherwise execution terminates.

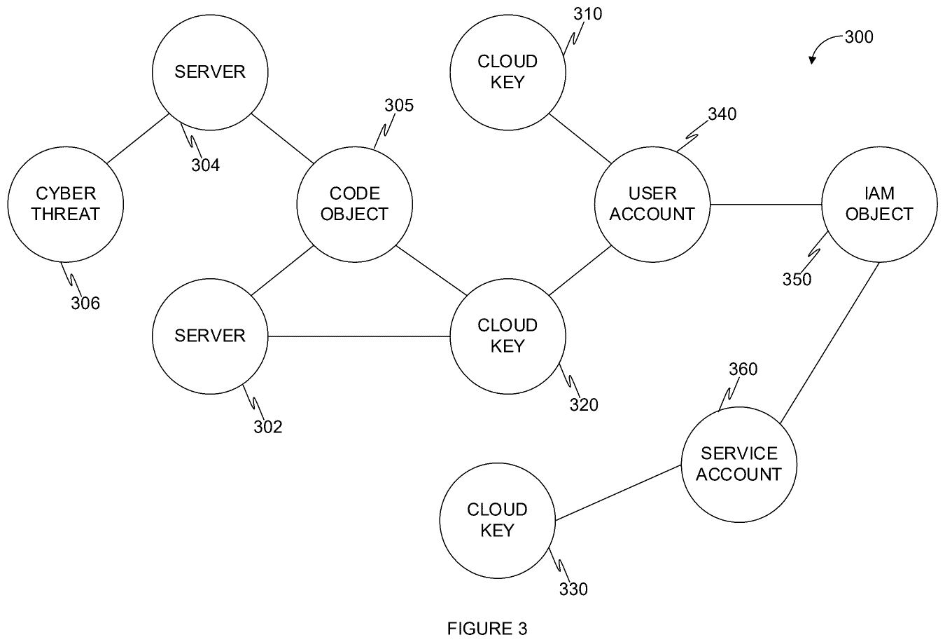

FIG. 3 is a schematic illustration of a portion of a security graph 300 for cybersecurity risk assessment of virtual instances in a cloud computing environment, implemented in accordance with an embodiment. The graph 300, which in an embodiment is stored in a graph database, includes a plurality of nodes. In an embodiment, a node represents a resource, principal, metadata, enrichment data, a cybersecurity issue, and the like.

In an embodiment, the graph 300 includes a first cloud key node 310 (representing a first cloud key) and a second cloud key node 320 (representing a second cloud key), which are connected to a user account node 340 (representing a user account). A third cloud key node 330 (representing a third cloud key) is connected to a service account node 360 (representing a service account). The user account node 340 and service account node 360 are connected to an identity and access management (IAM) object node 350 (representing an IAM object).

In an embodiment, a cloud key provides temporary access, permanent access, and the like, between a first workload and a second workload. In some embodiments, one or more first workloads and one or more second workloads may be on the same tenant, on different tenants, or on a combination thereof. In an embodiment, cloud keys are embedded into text configuration files, structured configuration files (e.g., JSON, YAML, XML, etc.), scripts, source code, and the like. Example implementations of cloud keys include AWS IAM access keys, OAuth® refresh tokens, access tokens, and the like.

By generating a security graph 300 including such nodes and populating it with data representing the cloud computing environment allows assessing of cybersecurity risks. For example, if a first cloud key is compromised, it is readily apparent what other objects are vulnerable as a result, by querying the security graph 300 and detecting cloud entities which are represented by nodes connected to, for example, a node representing the first cloud key. In an embodiment each node further stores metadata and data relating to the object. For example, a cloud key node 320 may include therein a unique account identifier.

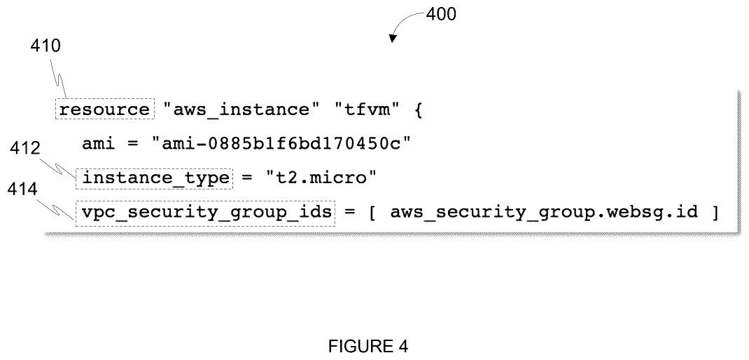

In an embodiment, a code object is represented by a code object node 305. In some embodiments, a code inspector, such as the code inspector 180 of FIG. 1, is configured to detect code objects in a configuration code, and generate an instruction, which when executed by a graph database, causes the graph database to generate the code object node 305. In an embodiment, a code object includes a plurality of data fields, such as discussed in more detail with respect to FIG. 4 below. In some embodiments, a code object node 305 includes a plurality of data fields, populated with values extracted (e.g., by a code inspector) from the configuration code.

In certain embodiments, the code inspector is configured to query the security graph 300 to detect a resource node having a data field value which matches a data field value of the code object. For example, the code object 305 includes, in an embodiment, a data field value which is shared with a first resource node 302 representing a first web server, and with a second resource node 304 representing a second web server. In an embodiment, the data field indicates that the first web server and the second web server, represented respectively by the first resource node 302 and the second resource node 304, are deployed based on the code object represented by the code object node 305.

In certain embodiments, an edge is generated between the code object node 305 and the first resource node 302, in response to determining that the resource (i.e., the server) represented by the first resource node 302 was deployed based on the code object represented by the code object node 305.

In some embodiments, the security graph 300 further includes a representation of a cybersecurity issue, such as security issue node 306. For example, a misconfiguration is represented by a node in the security graph, in an embodiment. In an embodiment the security issue node 306 representing a cybersecurity issue is connected to the first resource node 304 which represents a resource. This indicates that the resource includes the cybersecurity issue. For example, an inspector is configured to detect a cybersecurity issue, and detects the cybersecurity issue on a software container which is inspected by the inspector. In an embodiment, the security graph 300 is updated to include a node representing the software container (e.g., first resource node 302) connected to a node representing the cybersecurity issue (e.g., security issue node 306).

In some embodiments, an instruction is generated to inspect the code object represented by the code object node 305 to determine if the cybersecurity issue represented by security issue node 306 originates from the code object. In certain embodiments, an inspection instruction is generated to inspect a second resource, in response to detecting a cybersecurity issue associated with the first resource, wherein the first resource is represented by a first resource node 302, which is connected to a code object node 305, the code object node 305 further connected to a second resource node 304 representing the second resource.

In certain embodiments, generating a node representing a cybersecurity issue allows to reduce redundant information stored in a graph database, where storing a connection requires less resources than storing information about the cybersecurity issue in each node representing a resource where the cybersecurity issue is detected. This allows compact representation, thereby reducing computer resource consumption. This further allows to rapidly detect all resources having a certain cybersecurity issue, as rather than querying each node to determine if the node includes information on a specific cybersecurity issue, a single node is queried to detect nodes connected to it. This reduces the amount of processing required on a database search.

In an embodiment, a resource is represented by a resource node 302. The cloud key represented by cloud key node 310 is detected, for example by an inspector, on the resource. In an embodiment, an inspector is configured to generate an instruction which when executed by the graph database causes a connection between the cloud key node 310 and the resource node 302. In certain embodiments, the resource node 302 is a data structure which includes a plurality of data fields. A data field receives a value which represents an attribute. For example, a data field is, in an embodiment, a resource type identifier, an application identifier, a VPC identifier, an instance type identifier, and the like.

FIG. 4 is an example of a code object, shown in accordance with an embodiment. A code object 400 includes an object type 410. The object type 410 indicates, in this example, that this code object is a resource type, i.e., executing instructions related to this object will deploy a resource in a cloud computing environment. The object type further includes data fields, such as instance type data field 412 and network association data field 414. The instance type 412 specifies what type of resource is to be deployed, in this case the instance type is a t2.micro, which is a processing instance used in the AWS cloud computing environment. The network association field 414 indicates, in this example, that the instance should be associated with a specific virtual private cloud (VPC). In this example the code object is a data structure having parameters (or data fields) which can be customized to generate resources, accounts, and the like, in a cloud computing environment.

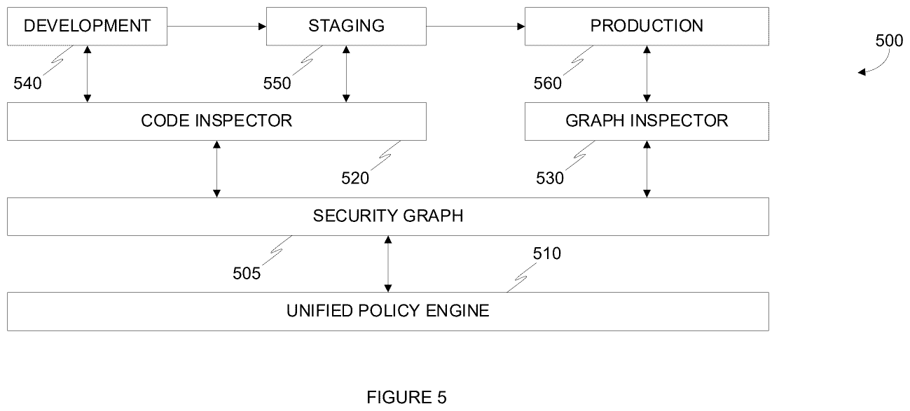

FIG. 5 is an example of a schematic illustration 500 of a unified policy engine across multiple cloud environments, implemented according to an embodiment. In some embodiments, the unified policy engine is further utilized across cloud service providers. In an embodiment, a unified policy engine 510 is a policy engine which is utilized across a full technology stack. In an embodiment, a production cycle begins in a development environment 540. The development environment 540 includes, in an embodiment, sandboxed applications, infrastructure as code (IaC) declaratory code (such as configuration code 120 of FIG. 1), and the like. For example, Microsoft® Azure offers Azure DevOps Services which may serve as a cloud based development environment.

After a workload, policy, other change, and the like, is approved in infrastructure from the development environment 540, it is implemented in a staging environment 550. For example, a workload is deployed in the staging environment 550, a policy change is updated into a policy engine of the staging environment 550, and the like. A staging environment 550 is implemented, in an embodiment, as a cloud computing environment which is identical, substantially similar, and the like, to a production environment 560 in which the workload, the change, and the like, is ultimately deployed.

The purpose of a staging environment 550 is to provide a final testing environment which simulates the production environment 560 to as high a degree as possible. This allows to eventually deploy a workload, for example, with a relatively high certainty that the workload will perform as expected. Where a workload does not perform as expected, it may be returned to the development environment 540, in order to address any problems which were detected during deployment in the staging environment 550.

A workload which passes testing of the staging environment 550 may be implemented in a production environment 560. The production environment is a cloud computing environment which is in real time use, and provides services, functionality, resources, and the like, to users, service accounts, and the like.

In an embodiment, a code object is stored as code in a configuration code file, stored in the development environment 540. The configuration code file is executed, in an embodiment, for example by Terraform®, to deploy a workload, virtual instance, user account, and the like in the staging environment 550, based on the code object.

In certain embodiments, the deployed workload is tested in the staging environment 550, for example, by executing performance tests, load tests, and the like. If the deployed workload passes the tests in the staging environment 550, the code object is added, in an embodiment, to a main configuration code file (or committed, per industry term). The next time the main configuration code file is utilized, the code object is used (e.g., to deploy instances) in the production environment 560.

In an embodiment, inspectors are utilized to inspect for cybersecurity objects which are indicative of cybersecurity issues. In some embodiments, the inspectors are utilized across different cloud computing environments. For example, in an embodiment a code inspector 520 is configured to inspect for a cybersecurity object in each of the development 540 and staging 550 environments. A cybersecurity object is, in an embodiment, an application identifier, an operating system identifier, a weak password, an exposed password, an exposed certificate, a misconfiguration, and the like.

As another example, in an embodiment a graph inspector 530 is configured to inspect for graph objects (i.e., objects which are represented in a security graph) in the production environment 560. While FIG. 5 shows inspector workloads operating in different environments, this is merely for simplicity and pedagogical purposes. In certain embodiments, a first inspector, inspecting for a first object type, is configured to inspect each cloud environment for the first object type. In other embodiments, a unique inspector for the first object type is implemented for each compute environment. In some embodiments, an inspector is configured to inspect for a cybersecurity object having a data field, attribute, or other value configured to a predetermined value.

A system administrator may make changes to a production environment policy in response to detecting a real-world event (as opposed to theoretical test cases done in staging). For example, in response to detecting a vulnerability, a system administrator may update, or create, a policy to address the vulnerability. The policy is stored in a cloud environment of the production environment 560, which is not accessible to the staging environment 550, and in some embodiments is not readable by the development environment 540. Further, there is no way for an operator of the development environment 540 or staging environment 550 to know about the policy change. Therefore, operators of the development environment 540 and staging environment 550 may continue to create workloads which violate the policies set forth in the production environment 560. This is not necessarily a design flaw, as it is advantageous to have a production and a staging environment completely isolated from each other. This ensures that changes in the staging environment do not spill over to a production environment.

By utilizing the inspector workloads across all the compute environments, and representing the detected objects in a security graph 505, a unified policy engine 510 may be utilized, which can be used to implement a policy across all the compute environments. In an embodiment, a code object is detected in the development environment 540. The code object is inspected and the content of the code object (e.g., identifier, type, etc.) is utilized to search a security graph 505 for a match. In an embodiment, a node matching the content is associated with a policy which is accessible to the unified policy engine 510.

In some embodiments, a check is performed to determine if an instance generated based on the detected code object would comply with the associated policy. For example, an instruction is generated which deploys an instance, and an associated policy is applied. In some embodiments, data from the node representing the code object is used in applying the associated policy on the data of the node representing the code object. Thus, a code object can be failed at the development environment 540 based on a policy of the production environment 560, without wasting resources and time of going through staging, for example.

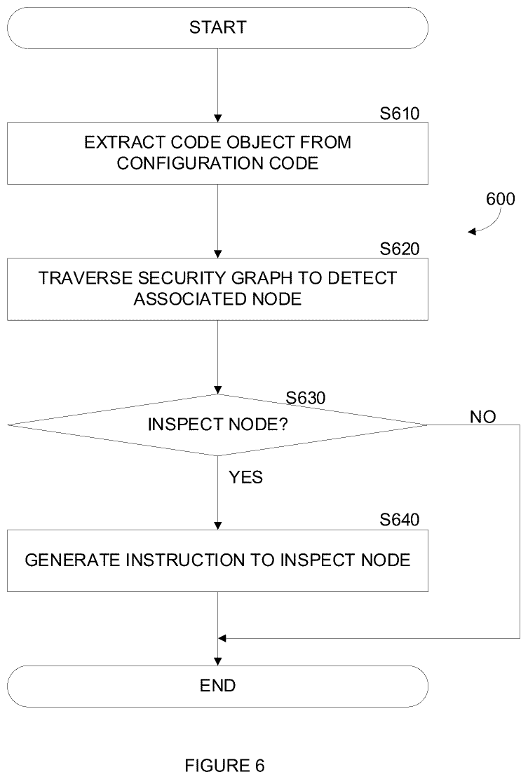

FIG. 6 is an example flowchart 600 for generating an inspection instruction based on a detected code object, implemented in accordance with an embodiment.

At S610, a code object is extracted from a configuration code file. The configuration code file includes a plurality of code objects, at least a portion of which include instructions that, when executed by an orchestrator, cause generation of principals or resources in a cloud computing environment.

In an embodiment, the configuration code file 120 is implemented in a declaratory computer language. In certain embodiments, the code object includes a plurality of data fields, such as explained in more detail with respect to FIG. 4 above. In some embodiments, the code object is detected in a version control system, code repository, combination thereof, and the like.

At S620, a node is detected which is associated with a code object. In an embodiment, a security graph is traversed to detect the node which is associated with the code object. For example, a security graph is queried based on values of data fields of the code object. A data field may be, for example, an identifier of an instance, an instance type, an identifier of an associated network, and the like. In an embodiment, a node is associated with a code object if, for example, a value of a data field of the node and a value of the data field of the code object match.

In the example of FIG. 4 above the code object may be matched to a node in the security graph which represents a VPC. In an embodiment, a code object matches a node, if for example a workload, virtual instance, and the like, is generated based on the code object represented by the node.

In certain embodiments, an orchestrator generates a state file, which includes a mapping between a code object in a configuration code file, and an identifier of an instance deployed in a cloud computing environment. In some embodiments, a state file is accessed to detect the mapping, and the mapping is represented in a security graph by connecting a node representing a code object to a node representing a deployed instance.

In an embodiment, a code object is correlated to a cloud object by querying a CI job through a command line interface (CLI) which is utilized to deploy cloud objects in a cloud computing environment based on the code object.

At S630, a check is performed to determine if the instance which is represented by the detected node should be inspected. If ‘yes’ execution continues at S640. If ‘no’ execution may terminate, or in another embodiments continue at S620 with another node. In yet another embodiment, if the check returns ‘no’ execution may continue at S610 with another code object. Inspection of an instance is initiated, in an embodiment, in response to determining that inspection of an instance in a first cloud computing environment (e.g., production environment) detected a cybersecurity issue. The instance is represented in a security graph by a node which is connected to a node representing a code object from which the instance was deployed. The node representing the code object is further connected to another node representing another instance, deployed in a second cloud computing environment. In an embodiment, the security graph is traversed to detect another node, and inspection of the instance represented by the another node is initiated.

At S640, an instruction to initiate an inspection of a workload corresponding to the node is generated. Inspecting the workload includes, in an embodiment, generating an inspectable disk of the workload, for example, by generating a disk clone, and providing access to the cloned disk through an inspection service account to an inspector (such as inspector 160 of FIG. 1). In an embodiment, a volume may be mounted based on the cloned disk, which the inspector 160 may access to inspect for at least a data object. In some embodiments, the cloned disk is released (i.e., resources are deallocated) in response to receiving an indication from an inspector that inspection of the cloned disk is complete.

Generating inspection instructions based on code objects is advantageous as it reduces the requirement to inspect a network environment for virtual workloads. Instead, new workloads may be discovered by inspecting the code which generates them, while security issues in workloads in a production environment may in turn be traced back to code objects from which they are generated.

In other embodiments, an inspection instruction is generated for a first instance deployed in a first cloud computing environment, in response to detecting that a corresponding second instance deployed in a second cloud computing environment includes a cybersecurity issue, wherein the first instance and the second instance are deployed based on a single code object. In some embodiments, the inspection instruction is generated in response to detecting that a first resource node representing the first instance is connected to a code object node representing the code object, and the code object node is further connected to a second resource node representing the second instance. In some embodiments the second resource node is connected to a cybersecurity issue node, representing a cybersecurity issue.

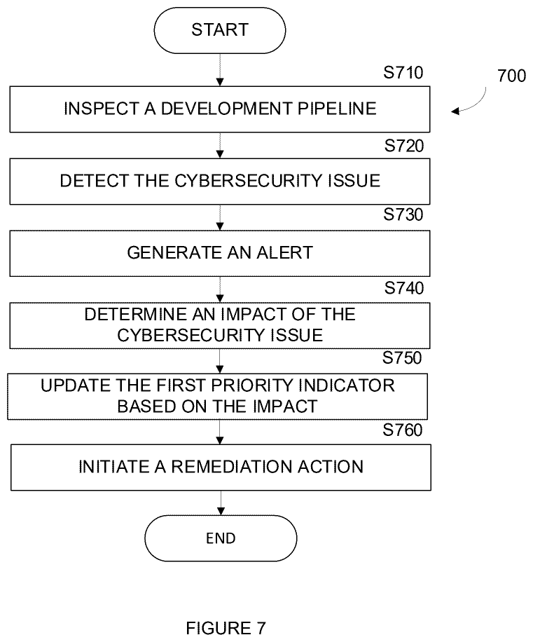

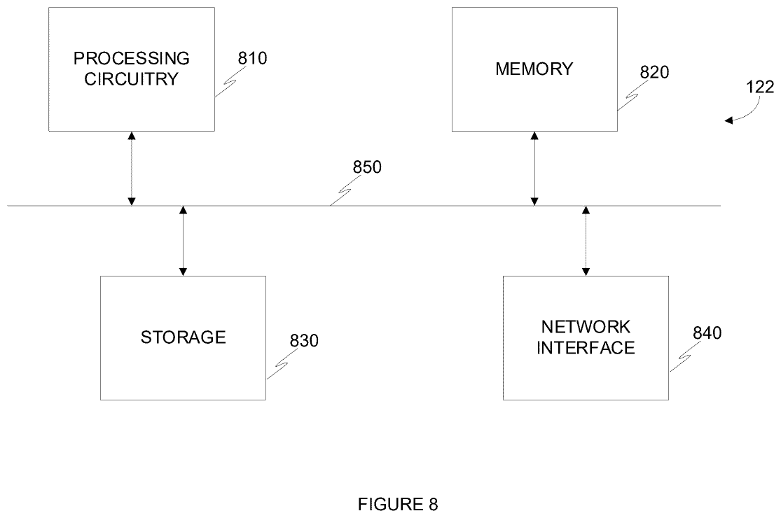

FIG. 7 is an example flowchart 700 for detecting a misconfiguration and a threat, implemented in accordance with an embodiment.

At S710, a development pipeline is inspected. In some embodiments, the development pipeline is of a cloud computing environment. In an embodiment, the development pipeline of a production cloud computing environment is inspected for a cybersecurity issue.

In an embodiment, the development pipeline includes a testing environment, a development environment, a software monitoring tool configured to monitor workloads in a production environment, a combination thereof, and the like.

In some embodiments, the development pipeline is inspected by an inspector configured to inspect a code object, a workload, a cloud entity, a combination thereof, and the like. In certain embodiments, the inspector is configured to detect a cybersecurity object. In an embodiment, the cybersecurity object indicates a cybersecurity issue, a cybersecurity risk, a cybersecurity threat, a misconfiguration, a vulnerability, an exposure, a malware, a combination thereof, and the like.

At S720, a cybersecurity issue is detected. In some embodiments, the cybersecurity issue is detected in the development pipeline. In an embodiment, a code object, a workload, a cloud entity, a cybersecurity object, a combination thereof, and the like, indicates a cybersecurity issue.

In an embodiment, a cybersecurity issue is detected based on a plurality of detected objects, entities, a combination thereof, and the like. According to certain embodiments, a combination of a cybersecurity object and a cloud entity are a cybersecurity issue known as a toxic combination.

In some embodiments, a cybersecurity issue is represented in a security database. In certain embodiments, the representation of the cybersecurity issue is connected to a representation of a code object, a cloud entity, a workload, a combination thereof, and the like. In an embodiment, connecting a representation of a cybersecurity issue to a representation of a code object, cloud entity, etc., indicates that the cybersecurity issue is detected on the code object, cloud entity, etc.

In an embodiment, a cybersecurity issue is detected in a code object. For example, in some embodiments, a code object located in a code repository, such as a version control system, is inspected for a cybersecurity object which indicates a cybersecurity issue. In an embodiment, inspecting a code object includes performing static analysis on the code object. In some embodiments, the code object is a code object in an infrastructure as code platform. For example, in certain embodiments, the code object is a Terraform® code object.

At S730, an alert is generated. In certain embodiments, an alert is generated based on the detected cybersecurity issue. The alert includes a first priority indicator, in some embodiments.

In an embodiment, the priority indicator is generated based on a rule, a heuristic, a policy, a combination thereof, and the like. In some embodiments, the rule is based on a cloud entity, such as a principal.

For example, in an embodiment, a rule is based on a user role, such as an administrator role, which when detected in the context of a cybersecurity issue results in assigning a priority indicator of a high magnitude (e.g., ‘severe’), since administrator roles include the most permissive access to a computing environment.

In some embodiments, an alert priority is utilized in determining an order in which to initiate remediation actions. Typically, alerts having more severe priority levels are addressed prior to alerts having lower priority levels. Therefore, it is advantageous to assign a correct priority to an alert, at least in order to correctly prioritize remediation.

At S740, an impact of the cybersecurity issue is determined. In some embodiments, an impact of the cybersecurity issue on the production cloud computing environment is determined.

According to an embodiment, an impact is determined by representing detected workloads, entities, cybersecurity objects, cybersecurity issues, and the like, in a security database, and applying a rule, a policy, a combination thereof, and the like, to the representation.

In an embodiment, an impact is, for example, a code object from a code environment which is directed to a system classified as ‘sensitive’ in a production environment, where the code object does not have a “code review mandatory” control turned on. By representing the code object, the system, the production environment, etc., in the security database, and connecting these representation elements, an impact is determined. In this example, the impact is classified as ‘critical’, for example by classifying based on preexisting alert rules.

At S750, the first priority indicator is updated. In an embodiment, the priority indicator is updated based on the determined impact. In some embodiments, the first priority indicator is updated to a second priority indicator. In certain embodiments, the first priority indicator is updated to a second priority indicator based on the determined impact of the cybersecurity issue.

According to an embodiment, the second priority indicator is a higher priority, a lower priority, and the like. In certain embodiments, a ticket system, an alert system, and the like, is updated with the second priority, for example by writing to a data record representing the alert with a value associated with the second priority.

In an embodiment, a priority indicator is a qualitative value, a quantitative value, a combination thereof, and the like. According to an embodiment, a qualitative value is, for example, ‘critical’, ‘high’, ‘medium’, low, and the like. In some embodiments, a quantitative value is, for example, a numerical value between ‘1’ and ‘10’, a numerical value between ‘1’ and ‘100’, and the like.

At S760, a remediation action is initiated. In an embodiment, a remediation action is initiated in the cloud computing environment. In certain embodiments, a remediation action is initiated in the cloud computing environment based on the second priority indicator.

For example, according to some embodiments, an order of initiating remediation actions in the computing environment is determined based on a priority associated with an alert. In some embodiments, a remediation action initiated in the computing environment for a first alert having a first priority indicator is initiated prior to a remediation action initiating in the computing environment for a second alert having a second priority indicator, where the second priority indicator is lower (e.g., has a lower value) than the first priority indicator.

According to an embodiment, a remediation action includes removing a code object, removing a portion of a code object, replacing a first portion of a code object with a second portion of code, revoking access from a principal, revoking access to a resource, revoking access from a resource, sandboxing a resource, terminating a workload, a combination thereof, and the like.

FIG. 8 is an example schematic diagram of an inspector 160 according to an embodiment. The inspector 160 includes, according to an embodiment, a processing circuitry 810 coupled to a memory 820, a storage 830, and a network interface 840. In an embodiment, the components of the inspector 160 are communicatively connected via a bus 850.

In certain embodiments, the processing circuitry 810 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (Al) accelerators, general-purpose microprocessors, microcontrollers, digital signal processors (DSPs), and the like, or any other hardware logic components that are configured to perform calculations or other manipulations of information.

In an embodiment, the memory 820 is a volatile memory (e.g., random access memory, etc.), a non-volatile memory (e.g., read only memory, flash memory, etc.), a combination thereof, and the like. In some embodiments, the memory 820 is an on-chip memory, an off-chip memory, a combination thereof, and the like. In certain embodiments, the memory 820 is a scratch-pad memory for the processing circuitry 810.

In one configuration, software for implementing one or more embodiments disclosed herein is stored in the storage 830, in the memory 820, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 810, cause the processing circuitry 810 to perform the various processes described herein, in accordance with an embodiment.

In some embodiments, the storage 830 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 840 is configured to provide the inspector 160 with communication with, for example, the network 140, according to an embodiment.

It should be understood that the embodiments described herein are not limited to the specific architecture illustrated in FIG. 8, and other architectures may be equally used without departing from the scope of the disclosed embodiments.

Furthermore, in certain embodiments the inspector 160, the policy engine 190, the code inspector 180, the security graph 170, a combination thereof, and the like, may be implemented with the architecture illustrated in FIG. 8. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for cybersecurity remediation prioritization in a cloud computing environment, comprising:
inspecting a development pipeline of a production cloud computing environment for a cybersecurity issue;
statically analyzing a code object utilized to deploy a resource in the production cloud computing environment;
detecting the cybersecurity issue in the code object of the development pipeline based on a result of statically analyzing the code object;
generating an alert based on the detected cybersecurity issue, the alert including a first priority indicator;
determining an impact of the cybersecurity issue on the production cloud computing environment;
updating the first priority indicator to a second priority indicator based on the determined impact; and
initiating a remediation action in the cloud computing environment based on the second priority indicator.

2. The method of claim 1, further comprising:
inspecting an infrastructure as code (IaC) platform of the development pipeline for the cybersecurity issue.

3. The method of claim 2, further comprising:
detecting a code object in the IaC platform, the code object utilized to deploy a workload in the production cloud computing environment.

4. The method of claim 3, further comprising:
inspecting the code object for the cybersecurity issue.

5. The method of claim 1, further comprising:
inspecting a CI/CD environment of the development pipeline for the cybersecurity issue.

6. The method of claim 1, further comprising:
inspecting the production cloud computing environment for a cybersecurity object; and
detecting a cybersecurity risk based on the cybersecurity object and the cybersecurity issue.

7. The method of claim 1, further comprising:
determining the impact of the cybersecurity issue further on an entity of the production cloud computing environment.

8. The method of claim 7, further comprising:
inspecting a cloud log of the production cloud computing environment for a data record respective of the entity; and
detecting a compromised entity in response to detecting a type of the data record.

9. The method of claim 8, further comprising:
initiating another remediation action based on the detected compromised entity.

10. (canceled)

11. A non-transitory computer-readable medium storing a set of instructions for cybersecurity remediation prioritization in a cloud computing environment, the set of instructions comprising:
one or more instructions that, when executed by one or more processors of a device, cause the device to:
inspect a development pipeline of a production cloud computing environment for a cybersecurity issue;
statically analyzing a code object utilized to deploy a resource in the production cloud computing environment;
detect the cybersecurity issue in the code object of the development pipeline based on a result of statically analyzing the code object;
generate an alert based on the detected cybersecurity issue, the alert including a first priority indicator;
determine an impact of the cybersecurity issue on the production cloud computing environment;
update the first priority indicator to a second priority indicator based on the determined impact; and
initiate a remediation action in the cloud computing environment based on the second priority indicator.

12. A system for cybersecurity remediation prioritization in a cloud computing environment comprising:
one or more processors configured to:
inspect a development pipeline of a production cloud computing environment for a cybersecurity issue;
statically analyzing a code object utilized to deploy a resource in the production cloud computing environment;
detect the cybersecurity issue in the code object of the development pipeline based on a result of statically analyzing the code object;
generate an alert based on the detected cybersecurity issue, the alert including a first priority indicator;
determine an impact of the cybersecurity issue on the production cloud computing environment;
update the first priority indicator to a second priority indicator based on the determined impact; and
initiate a remediation action in the cloud computing environment based on the second priority indicator.

13. The system of claim 12, wherein the one or more processors are further configured to:
inspect an infrastructure as code (IaC) platform of the development pipeline for the cybersecurity issue.

14. The system of claim 13, wherein the one or more processors are further configured to:
detect a code object in the IaC platform, the code object utilized to deploy a workload in the production cloud computing environment.

15. The system of claim 14, wherein the one or more processors are further configured to:
inspect the code object for the cybersecurity issue.

16. The system of claim 12, wherein the one or more processors are further configured to:
inspect a CI/CD environment of the development pipeline for the cybersecurity issue.

17. The system of claim 12, wherein the one or more processors are further configured to:
inspect the production cloud computing environment for a cybersecurity object; and
detect a cybersecurity risk based on the cybersecurity object and the cybersecurity issue.

18. The system of claim 12, wherein the one or more processors are further configured to:
determine the impact of the cybersecurity issue further on an entity of the production cloud computing environment.

19. The system of claim 18, wherein the one or more processors are further configured to:
inspect a cloud log of the production cloud computing environment for a data record respective of the entity; and
detect a compromised entity in response to detecting a type of the data record.

20. The system of claim 19, wherein the one or more processors are further configured to:
initiate another remediation action based on the detected compromised entity.

21. (canceled)
